(19) United States
(12) Patent Application Publication
(10) Pub. No.: US 2006/0120063 A1
(43) Pub. Date: Jun. 8, 2006

(54) Brightness controllable luminescent fan

(75) Inventor: Chen Hui Lai, Taipei Hsien (TW)

Correspondence Address: BIRCH STEWART KOLASCH & BIRCH, PO BOX 747, FALLS CHURCH, VA, 22040-0747, US

(73) Assignee: POWER COOLER ENTERPRISE CO., LTD.

(21) Appl. No.: 11/000,979

(22) Filed: Dec. 2, 2004

(51) Int. Cl. F21V 33/00

(52) U.S. Cl. 362/96; 362/101; 362/253

(57) ABSTRACT

A brightness controllable luminous fan comprises a frame, a fan body with a leaves body, a stator set and a rotator set. The fan body further comprises a driving coil set installed on the surface of a fixing shaft at the center of the frame. The leaves body is pivotally connected on the fixing shaft and a magnetic ring wound around the driving coil is further installed at the inner wall face of the leaves body. The stator set is fixed at the upper end of the fixing shaft and constituted by an electromagnet set. The rotator set is fixed in the leaves body, at least one lighting controlling circuit is connected with the rotator set. Whereby, the intensity of an induction current yielded from an induction coil rotated in the magnetic field can be controlled effectively through the electromagnet set. Therefore, a high brightness of lighting effect can still be generated in the luminous bodies even if the leaves are rotated at a low speed.

### BACKGROUND OF THE INVENTION

1. Field of the Invention

The present invention relates to a brightness controllable luminescent fan, and more particularly to an active luminescent structure attached on a fan in which the brightness thereof can be controlled effectively.

2. Description of Related Art

Accompanying the development of the computer technology, every kind of current electronic element has a great progress on work execution efficiency. But, the temperature of the electronic element is too high owing to the increase of power consumption so that the electronic element is overheated. Therefore, a high effective fan is always installed in the housing of a computer or central processing unit to drive air to yield a convection effect to reduce the working temperature of a computer mainframe so as to protect electronic parts in the central processing unit from overheating. Whereby, the mainframe can be kept maintaining in a normal state to allow the system to be kept working normally.

For satisfying the vision pleasure of a user, a actively luminescent fan structure is developed, a typical structure thereof is disclosed in Taiwan Patent No. 590,166 “self-excited light type cooling fan” characterized in that a self excited light unit set is disposed on the inner circumference of a cover of a leaves body, and this self-excited light unit set is constituted by a circuit board fixed in the cover, second circuit component fixed at the bottom of the circuit board and second magnetic element fixed at a housing and wound around the second coil component, in which the second coil component is driven by the leaves body to rotate in the second magnetic element to yield a conductive current in the second coil set so as to allow luminous elements installed on the circuit plate of the self-excited light unit set to be lighted effectively. And, the higher the rotation speed of the leaves body becomes, the higher the brightness of luminous elements also becomes.

Although the active illumination of the fan can be attained effectively according to the patent mentioned above, but if the leaves body of the fan is rotated at lower speed, the conductive current yielded from the second coil set is caused to be lower, and the brightness of luminous bodies is caused to be too low and even not to be able to be lighted up.

Furthermore, because the brightness control must be done by adjusting the rotation speed of the leaves when the brightness of the light in the structure mentioned above is adjusted, if the light is intended to be adjusted to be at a low brightness, the rotating speed of the leaves body must be controlled at a lower rotating speed, the cooling effect of the fan is influenced a lot.

Therefore, that how to allow the active illumination structure of the fan not to be influenced by the rotating speed of the leaves body so as to control the brightness of the luminous body effectively is the topic that the present invention studies intensively.

In view of the defects mentioned above, the inventor of the present invention put an effort on the light controlling structure and the present invention is finally proposed.

### SUMMARY OF THE INVENTION

The main object of the present invention is to provide a brightness controllable luminescent fan, allowing the change of a conductive current yielded from a conductive coil set to adjust the brightness of luminous bodies effectively only by increasing or decreasing the strength of the magnetic field of an electromagnet set while adjusting the brightness of the luminous bodies.

Another object of the present invention is to provide a brightness controllable luminescent fan, allowing a conductive current provided from a conductive coil set to light controlling circuit to be changed to control the brightness of luminous bodies by adjusting and controlling the magnetic field of an electromagnet set when the rotating speed of fan leaves is kept constant.

### BRIEF DESCRIPTION OF THE DRAWINGS

The present invention can be more fully understood by reference to the following description and accompanying drawings, in which:

FIG. 1 is an explosive view, showing a brightness controlling luminescent fan according to the present invention.

FIG. 2 is a cross sectional view, showing a brightness controlling luminescent fan according to the present invention.

FIG. 3 is a circuit diagram of a brightness controlling luminescent fan according to the present invention.

FIG. 4 is an explosive view, showing a brightness controlling luminescent fan of another preferred embodiment according to the present invention.

FIG. 5 is a cross sectional view, showing a brightness controlling luminescent fan of another preferred embodiment according to the present invention.

### DETAILED DESCRIPTION OF THE PREFERRED EMBODIMENTS

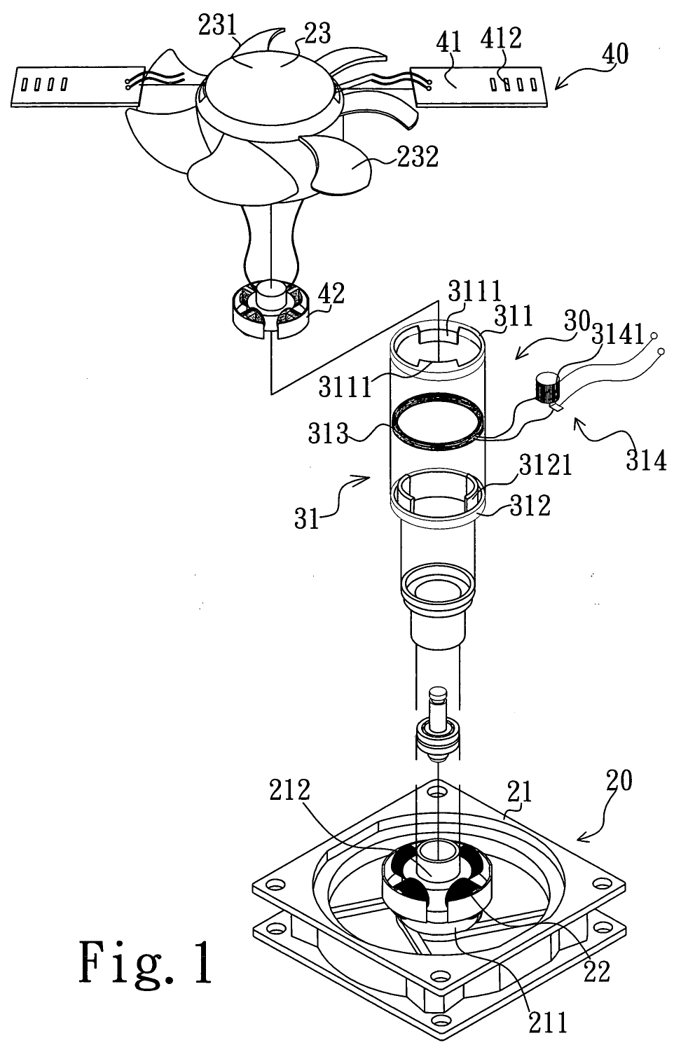

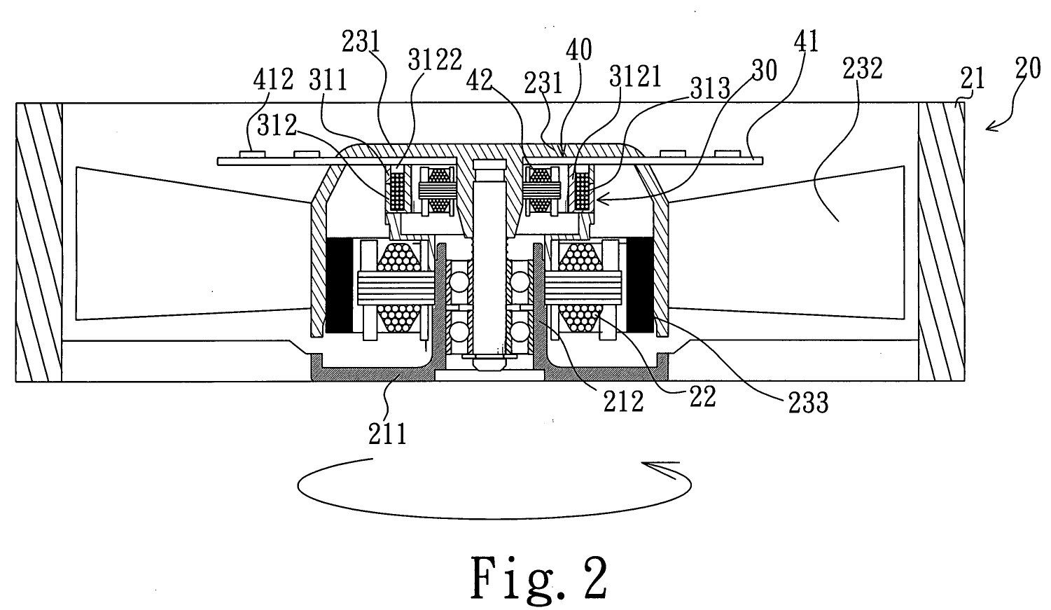

Please refer to FIGS. 1 and 2. FIGS. 1 and 2 are explosive and cross sectional views respectively showing components and a combination of a brightness controllable luminescent fan of a preferred embodiment according to the present invention. A rotating luminescent structure of a fan comprises a fan body 20, a stator set 30 and a rotator set 40, in which the fan body 20 is constituted by a frame 21, a driving coil set 22 and a leaves body 23. A base seat 211 is installed at the center of the frame 21 in which a hollow fixed shaft 212 is projected upward. The driving coil set 22 is installed on the surface of the hollow fixed shaft 212. The leaves body 23 having a cover body 231 is pivotally connected on the hollow fixed shaft 212; a plurality of leaves are disposed around the circumference of the cover body 231 for generating an axial air current. A magnetic coil 233, which is wound around the driving coil set 22, is installed inside of the cover body 231 for generating an electromagnetic induction with the magnetic coil 233 when the driving coil set 22 is ON to allow the magnetic coil 233 to drive the leaves body 23 to revolve around the hollow fixed shaft 212. Furthermore, the stator set 30 is fixed on the hollow fixed shaft 212. The stator set 30 has a magnetic field adjustable electromagnet 31, which is constituted by a upper magnetic ring 311, a lower magnetic ring 312 and a magnetic ring 313. At least one pair of L type first magnetic portions 3111, which are faced to each other, is extended downward from the top of the upper magnetic ring 311. The lower magnetic ring 312 is fixed below the upper magnetic ring 311 and at least one pair of L type second magnetic portions 3121, which are faced to each other, is extended upward from the bottom of the lower magnetic ring 312. The number of the second magnetic portions 3121 is decided by the number of the first magnetic portions 3111 and the first magnetic portions 3111 and the second magnetic portions 3121 are interlaced to each other at an inner wall face formed by combining the upper and the lower magnetic rings 311 and 312 together. Here, a distance must be kept between the L type first and second magnetic portions 3111, 3121 and the inner wall face combined by the upper and lower magnetic rings 311, 312 so as to form an accepting groove 3122, as FIG. 2 shows. The magnetic coil 313 is wound on the inner side faces of the first and the second magnetic portions 3111 and 3121 to allow the magnetic coil 313 to be wound around and accept in the accepting groove 3122 as well as the magnetic coil 313 to be wound around and fixed in the upper and the lower magnetic rings 311 and 312. Besides, the two ends of the magnetic coil 313 are respectively connected to a voltage controlling circuit 314, which mainly consists of a variable resistor 3141. The current input to the magnetic coil 313 is controlled through the variable resistor 3141 to allow the magnetic coil 313 to magnetize the first and the second magnetic portions 3111 and 3121 to be an N or S pole. And, because the first and the second magnetic portions 3111 and 3121 are respectively disposed at the upper and the lower ends of the magnetic coil 313, the first and the second magnetic portions can be respectively decided to be a N or S pole according to the winding direction of the magnetic coil 313 or the flowing direction of the input current of the voltage controlling circuit 314. Furthermore, the rotator set 40 is fixed in the cover body 231 of the leaves body 23 and is constituted by a control circuit board 41 and at least one induction coil set 42. The control circuit board 41 is fixed in the cover body 231 and one end thereof is extended out of the surface of the cover body 231. And, the control circuit board 41 comprises a light controlling circuit 411 connected to at least one luminous body set 412. Besides, the control circuit 41 and the induction coil set 42 are connected to each other and the induction coil set 42 is similarly fixed in the cover body 231 to allow the induction coil set 42 to be rotated in the stator set 30 to generate an induction current and the light controlling circuit 411 connected thereto to control the luminous body set 412 to glitter effectively.

Furthermore, when the driving coil set 22 installed on the fan body 20 is ON, an electromagnetic induction is generated between it and the magnetic ring 313 to allow the magnetic ring 313 to drive the cover body 231 to be revolved on the hollow fixed shaft 212 so that the leaves 232 on the leaves body is allowed to rotate to disturb air to generate an axial current. When leaves body 23 is revolved on the hollow fixed shaft 212, the rotator set 40 inside of the cover body 231 is soon revolved in the stator set 30 installed at the upper end of the hollow fixed shaft 212. And, because the stator set 30 has an electromagnet 31, the magnetic field yielded from the magnetic coil 313 in the electromagnet set 31 is controlled by the voltage controlling circuit 314 connected therewith to allow the upper and the lower magnetic rings 311 and 312 respectively disposed at the upper and the lower ends of the magnetic coil 313 be respectively magnetized to a magnet with a N or S pole. Because the first and the second magnetic portions respectively extended from the upper and the lower magnetic rings 311 and 312 are equally interlaced at the inner wall face combined by the upper and the lower magnetic rings 311 and 312, when the rotator set 40 is revolved in the stator set 30, it can be continuously and alternatively revolved in the N and the S magnetic poles generated from the first and the second magnetic portions 3111 and 3121 to allow the induction coil 42 on the rotator section 40 to cut the magnetic field to induce a current. Thereafter, the current is provided to the light controlling circuit 411 connected with the induction coil 42 to allow the luminous body set 412 to be lighted so that a dynamic lighting effect is yielded.

Furthermore, the stator set 30 has an electromagnet 31 in which the strength of a magnetic field can be adjusted and the both ends of the magnetic coil 313 in the electromagnet 31 is connected to a voltage controlling circuit 314 that can control the current input to the magnetic coil 313 through a variable resistor 3141 so as to decide the strength of the magnetic poles of the electromagnets to which the upper and lower magnetic rings 311 and 312 are magnetized. Therefore, the intensity of the induction current generated from the induction coil set 42 in the rotator set 40 depends on the magnetic field yielded from the electromagnet set 31 of the stator set 30. Whereby, the brightness of the luminous bodies can be adjusted by controlling the strength of the magnetic field of the electromagnet set 31 without influencing the cooling effect of the fan.

Therefore, when the rotating speed of the leaves body 23 is rather low, the voltage controlling circuit 314 connected with the magnetic coil 313 of the stator set 30 is adjusted to cause the current intensity input to the magnetic coil 313 to be changed so that the magnetic field yielded from the magnetic coil 313 of the stator set 30 to be increased to allow the induction coil set 42 to be rotated alternatively in the N and the S magnetic poles yielded from the first and the second magnetic portions 3111 and 3121 of the stator set 30 to cause a stronger induction current to be generated therein. Whereby, the luminous bodies of the luminous body set can be controlled to generate a high brightness of dynamic lighting effect without worrying about whether they are not bright or the brightness of them are too low, even if the leaves body 23 is in a state of low rotating speed.

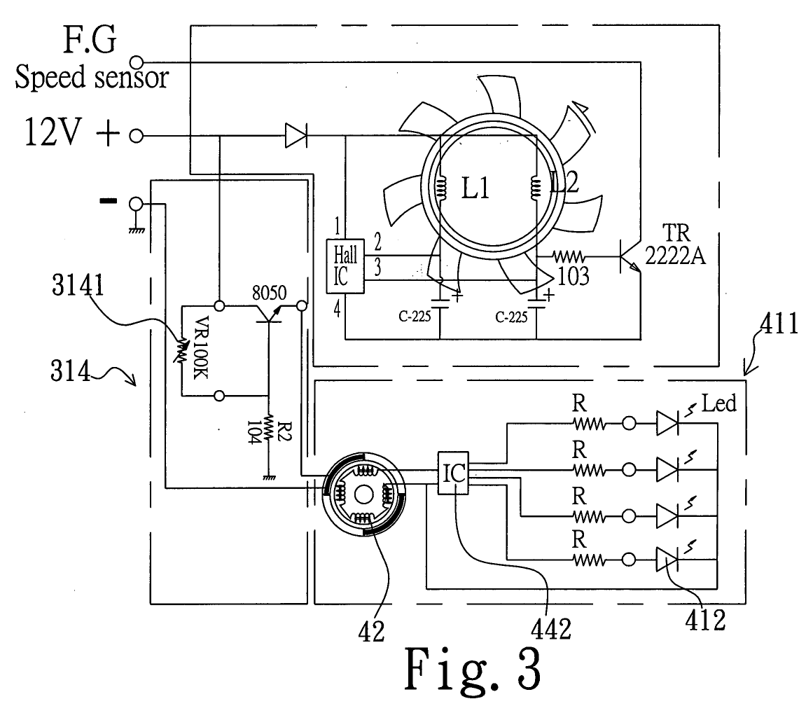

Please refer to FIG. 3. FIG. 3 is a circuit diagram of a brightness controllable luminescent fan according to the present invention. A brightness controlling circuit 411 of the rotator set 40 further comprises a control IC (integrated circuit) 442. The lighting time of a luminous body set 412 can be controlled through the control IC 442 to allow the control circuit 411 to yield a dynamic lighting effect such as an icon or trademark symbol on the leaves body 23 while rotating with the leaves body 23.

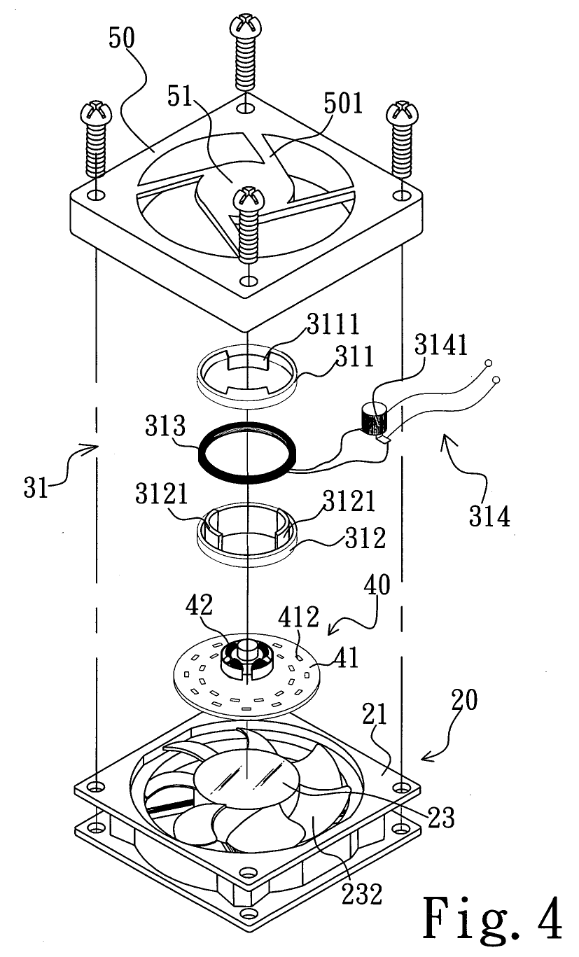

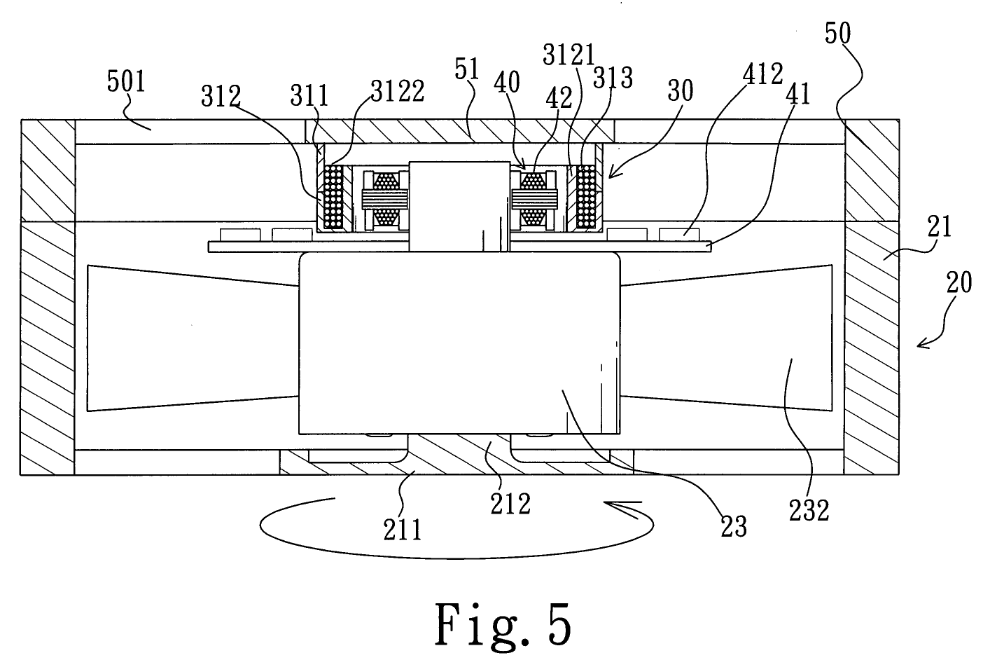

Please refer to FIGS. 4 and 5. FIGS. 4 and 5 respectively are explosive and cross sectional views, showing a brightness controllable luminescent fan of another preferred embodiment according to the present invention. A rotating luminous structure of a fan according to the present invention can further comprise a hollow frame 50. The hollow frame 50 is combined with the fan body 20. Moreover, a base seat 51 is disposed at the center of the hollow frame 50 and a plurality of fixing ribs 501 connected with the inner wall face of the hollow frame 50 are extended from the circumference of the base seat 51 to allow the base seat 51 to be fixed at the center of the hollow frame 50. The stator set 30 can be fixed on the base seat 51 and the rotator 40 can be fixed on the surface at the center of the leaves body 23 to allow the rotator set 40 to be surrounded by the stator set 30. Whereby, when the leaves body 23 is rotated to drive the rotator set 40 on the surface at the center thereof to be rotated in the stator set 30 and to allow the rotator set 40 to be rotated alternatively in the N and the S magnetic poles yielded from the electromagnet set 315 constituting the stator set 30 to cause the induction current to be provided to the light controlling circuit 411 on the stator set 40 to light the luminous bodies up.

From the statement mentioned above, the merits of the brightness controllable luminescent fan are the following: the intensity of the induction current generated from the induction coil rotated in a magnetic field can be controlled effectively through the electromagnet set in which the strength of the magnetic field can be adjusted so as to allow a high brightness of lighting effect being yielded in the luminous bodies when the leaves is rotated at a low speed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A brightness controllable luminescent fan, comprising:
a fan body, comprising:
a frame, fixed with a base seat at the center thereof,
a hollow fixing shaft being projected upward on said base seat;
a driving coil set, installed on the surface of said fixing shaft; and
a leaves body, pivotally connected to said fixing shaft, in which a magnetic coil is further installed at the inner wall face of said leaves body and wound at the outside of said driving coil set;
a stator set, fixed at the upper end part of the fixing shaft and constituted by an electromagnet set which is capable of adjusting the strength of a magnetic field, and
a rotator set, which is fixed in said leaves body and connected with at least one lighting controlling circuit, said lighting controlling circuit is extended out of the outer surface of said leaves body and provided with at least one set of luminous bodies.

2. A brightness controllable luminescent fan, comprising:
a fan body with a leaves body;
a hollow frame, connected with said fan body and provided with a base seat at the center of said frame;
a rotator set, installed on the surface of the center of said leaves body for generating an induction current, comprising at least one lighting controlling circuit installed at the center of sale leaves body, at least one luminous body installed on said controlling circuit;
a stator set, installed on said base seat of said hollow frame, constituted by an electromagnet set in which the strength of a magnetic field is adjustable and said stator set surround said rotator set.

3. The brightness controllable luminescent fan according to claim 1, wherein said electromagnet set comprises:
an upper magnetic ring in which at least one pair of L type first magnetic portions is extended downward at the upper end thereof;
a lower magnetic ring, fixed at the lower end of said upper magnetic ring, in which at least one pair of L type second magnetic portions is extended upward at the lower thereof, and accepting groove is formed between said first and said second magnetic portions and the inner wall faces of said upper and said lower magnetic rings;
a magnetic coil, wound around said first and said second magnetic portions to allow said magnetic coil to surround the inner wall faces of said upper and said lower coil equally; and
a voltage controlling circuit, connected with current input and output ends of said magnetic coils.

4. A brightness controllable luminescent fan according to claim 1, wherein at least one set of luminous bodies is connected to said lighting controlling circuit.

5. A brightness controllable luminescent fan according to claim 1, wherein a control integrated circuit connected with a plurality of luminous bodies is installed on said lighting controlling circuit.

6. A brightness controllable luminescent fan according to claim 3, wherein said voltage controlling circuit is connected to a variable resistor, thereby the current intensity input to said electromagnet is controlled through said variable resistor.

7. The brightness controllable luminescent fan according claim 2, wherein said electromagnet set comprises:
an upper magnetic ring in which at least one pair of L type first magnetic portions is extended downward at the upper end thereof;
a lower magnetic ring, fixed at the lower end of said upper magnetic ring, in which at least one pair of L type second magnetic portions is extended upward at the lower thereof, and accepting groove is formed between said first and said second magnetic portions and the inner wall faces of said upper and said lower magnetic rings;
a magnetic coil, wound around said first and said second magnetic portions to allow said magnetic coil to surround the inner wall faces of said upper and said lower coil equally; and
a voltage controlling circuit, connected with current input and output ends of said magnetic coils.

8. A brightness controllable luminescent fan according to claim 2, wherein at least one set of luminous bodies is connected to said lighting controlling circuit.

9. A brightness controllable luminescent fan according to claim 2, wherein a control integrated circuit connected with a plurality of luminous bodies is installed on said lighting controlling circuit.

10. A brightness controllable luminescent fan according to claim 7, wherein said voltage controlling circuit is connected to a variable resistor, thereby the current intensity input to said electromagnet is controlled through said variable resistor.
